(19) United States
(12) Patent Application Publication
(10) Pub. No.: US 2026/0358207 A1
(43) Pub. Date: Nov. 12, 2026

(54) Delipidating and Decolorizing Composition for Non-deformation Tissue Clearing and Use Thereof

(71) Applicant: Tsinghua University, Beijing (CN)

(72) Inventors: Kexin YUAN, Beijing (CN); Yixiao GAO, Beijing (CN)

(21) Appl. No.: 19/134,477

(22) PCT Filed: Jan. 25, 2024
(86) PCT No.: PCT/CN2024/074017

§ 371 Date: May 30, 2025

(30) Foreign Application Priority Data
Jan. 31, 2023 (CN) 202310047815.4

(51) Int. Cl. G01N 1/30

(52) U.S. Cl. CPC G01N 1/30

(57) ABSTRACT

A delipidating and decolorizing composition for issue clearing, comprising: a betain-based surfactant containing a fatty acid side chain; and an anionic surfactant containing a cholic acid side chain. A issue clearing method, comprising: treating a tissue sample by using the delipidating and decolorizing composition for tissue clearing.

### CROSS-REFERENCE TO RELATED APPLICATIONS

The present application is a U.S. National Phase Entry of International PCT Application No. PCT/CN2024/074017 having an international filing date of Jan. 25, 2024, which claims priority to Chinese Patent Application No. 202310047815.4 filed on Jan. 31, 2023. The above-identified applications are incorporated by reference herein in their entireties.

### TECHNICAL FIELD

The present invention relates to the field of tissue clearing, and particularly to a delipidating and decolorizing composition for non-deformation tissue clearing and use thereof.

### BACKGROUND

Tissue clearing (optical clearing) refers to a treatment of a tissue to reduce heterogeneity of refractive index in the tissue, so that light can penetrate a thick tissue for imaging, and an imaging effect is enhanced. Tissue clearing method makes it possible to image and reconstruct a complete three-dimensional structure of an animal tissue and organ, thus promoting a systematic understanding of the construction methods of complex biological systems.

The essence of tissue clearing is to remove or match components of non-uniform refractive index in the tissue, thereby reducing light refraction and reflection when light penetrates the refractive index interface, which means that the tissue becomes clear from a macroscopic point of view. The components with higher refractive index in the tissue include insoluble fibrin bundles (1.52), lipid membrane and lipid membrane-rich organelles (1.4-1.5), cytoplasm (1.4), etc., while the components with low refractive index are mainly extracellular fluid (1.33-1.37). Therefore, how to match these components with non-uniform refractive index to the same level is the key to the development of various tissue clearing methods. No matter what refractive index matching scheme is used, the lipid components in the tissue must be removed to ensure the transparency of the tissue. Therefore, the use of a delipidating and decolorizing reagent is a core step of tissue clearing.

Tissue clearing method can be roughly divided into three categories according to the principle: aqueous clearing method, organic solvent clearing method, and gel clearing method. Aqueous clearing methods, such as CUBIC-X, ScaleA2, ScaleS and other methods, mainly use high-concentration urea (4M) combined with a nonionic surfactant (for example, TritonX-100) for clearing. As a transmembrane protein denaturant, urea can form a hydrogen bond with a hydrophobic part of a protein structure to change the protein structure, thereby causing the protein that is insoluble itself or has a low degree of solvation to be highly solvated, or which is called hyperhydration. The refractive index of the hyperhydrated protein component will tend to be more consistent with the refractive index of a solvent. By combining the delipidating effect of urea and a surfactant, the whole tissue can achieve better transparency after a long soaking time. However, with this method, protein hyperhydration will lead to an irreversible denaturation of the protein and then a loss of endogenous fluorescence signal, and loosening of fibrin structure will lead to serious expansion and deformation of the whole tissue.

Organic solvent clearing methods, such as iDisco and BABB, utilize water-insoluble organic reagents for delipidating, dehydration and refractive index matching. Generally, organic solvents will denature the proteins more strongly than aqueous reagents, and it is difficult to maintain the stability of endogenous fluorescence, and at the same time, they will cause severe tissue shrinkage. Most organic solvent clearing reagents are toxic and there is a need to equip with safety precautions.

Gel clearing methods, such as CLARITY, PACT, SHIELD, use hydrogel grids such as polyacrylamide or epoxy resin to coat tissues to limit the movement of biological macromolecules therein, and then use high-concentration ionic strong detergents (e.g., SDS) to bind to lipids and usually use electric fields to accelerate negatively charged lipid masses to detach from tissues. Since SDS is also a relatively strong protein denaturant, it has a similar effect to aqueous clearing. Gel clearing method will also lead to the loss of fluorescence signal and the expansion and deformation of the tissue, but after using electric field promotion, the speed is faster than most aqueous clearing methods.

Because the clearing requires relatively large changes in the properties of various components of the tissue, almost all existing clearing methods cannot achieve the maintenance of the size and the tissue and the guarantee of tissue morphology, that is, the influence of clearing method itself on organ tissue structure cannot be ruled out. In addition, various clearing methods are insufficient to maintain endogenous fluorescence, so that weak signals cannot be detected more effectively. The maintenance of macroscopic morphology and the maintenance of endogenous fluorescence are both essentially the protection of protein structure. A high concentration of urea commonly used in the existing aqueous clearing method, an organic solvent in the organic solvent clearing method, and a high-concentration strong anionic detergent in the gel clearing method are all factors leading to protein denaturation.

The aqueous clearing ScaleS method uses a detergent with a low concentration, urea with a high concentration and sugars with a high concentration, to shrink the tissue to its original size after it expands. This is because the protein hyperhydration stretching force caused by the urea and the osmotic pressure caused by the sugars with a high concentration have reached a balance. However, this method still does not maintain the morphology of cells in principle microscopically, and there is a process in which the urea with a high concentration makes the tissue expand to about twice during the treatment process. Furthermore, this method has limited clearing because it does not effectively remove lipids.

Therefore, there is a need to develop a rapid and efficient delipidating and decolorizing formulation for tissue clearing that has no morphological effect on the tissues and maintains the activity of biological macromolecules in the tissues.

### SUMMARY

In view of the above problems in the prior art, a main object of the present invention is to provide a novel delipidating and decolorizing composition for tissue clearing, which has little influence on protein structure, does not cause macroscopic tissue deformation, and has a good protective effect on endogenous fluorescence, so that the tissue clearing can be realized efficiently and quickly.

Another object of the present invention is to provide a method for tissue clearing by using the delipidating and decolorizing composition for tissue clearing according to the present invention, which can avoid the deformation of the tissue during delipidating and decolorizing while maintaining endogenous fluorescence signal and protein activity.

Furthermore, since there is no or almost no deformation of the tissue during the process of treating tissues by using the delipidating and decolorizing composition for tissue clearing of the present invention, animals can be subjected to a transcardiac perfusion, and thus the uniformity and speed of clearing can be further accelerated. In addition, since the deformation of the tissue is not caused or hardly caused, the delipidating and decolorizing composition for tissue clearing of the present invention can also be applied to clearing of tissue sections on glass slides, so as to be applied to super-resolution imaging with high signal-to-noise ratio and high-volume rapid clearing imaging.

Thus, in one aspect, the present invention provides a delipidating and decolorizing composition for tissue clearing, and the composition comprises: a betaine-based surfactant containing a fatty acid side chain; and an anionic surfactant containing a cholic acid side chain. In some embodiments, in the delipidating and decolorizing composition for tissue clearing according to the present invention, the betaine-based surfactant containing the fatty acid side chain may be selected from one or more of lauramidopropyl hydroxysulfobetaine LHSB, dodecyldimethylhydroxypropyl sulfobetaine, and tetradecyldimethylhydroxypropyl sulfobetaine.

In some embodiments, in the delipidating and decolorizing composition for tissue clearing according to the present invention, the anionic surfactant containing the cholic acid side chain may comprise a side chain derived from a cholic acid-based compound. Preferably, the cholic acid-based compound may be selected from one or more of cholic acid, lithocholic acid, deoxycholic acid, and chenodeoxycholic acid. In some specific embodiments, the anionic surfactant containing the cholic acid side chain may further form an ammonium salt complex with an amine compound.

In some embodiments, the delipidating and decolorizing composition for tissue clearing according to the present invention may further comprise a fluidity enhancer.

In another aspect, the present invention provides a method for tissue clearing, and the method comprises treating a tissue sample with the delipidating and decolorizing composition for tissue clearing according to the present invention.

In some embodiments, the method for tissue clearing according to the present invention comprises: treating a tissue sample with a first delipidating and decolorizing composition; and
transferring the tissue sample treated with the first delipidating and decolorizing composition into a second delipidating and decolorizing composition,
wherein the first delipidating and decolorizing composition and the second delipidating and decolorizing composition may be the same or different.

In some specific embodiments, the first delipidating and decolorizing composition is different from the second delipidating and decolorizing composition. In some preferred embodiments, the first delipidating and decolorizing composition is free of a fluidity enhancer. In some preferred embodiments, the second delipidating and decolorizing composition comprises a higher content of a betaine-based surfactant containing a fatty acid side chain than the first delipidating and decolorizing composition.

In some embodiments, the method for tissue clearing according to the present invention further comprises holding the tissue sample treated with the delipidating and decolorizing composition in an aqueous refractive index matching liquid.

In the present invention, a new aqueous clearing, delipidating and decolorizing formula is provided by compounding a betaine-based surfactant, a cholic acid-based surfactant, and amines. By the delipidating and decolorizing composition for tissue clearing according to the present invention or the method for tissue clearing using the same, an excellent delipidating and decolorizing effect can be obtained without changing the morphology of the tissue, and further it is possible to protect endogenous fluorescence. The delipidating and decolorizing composition for tissue clearing of the present invention has a much higher delipidating efficiency than aqueous delipidating methods commonly used in the prior art (e.g., CUBIC-X), and can be used for transcardiac perfusion due to its characteristic that the morphology of the tissue is not changed, which can greatly accelerate the delipidating process, e.g., shortening the delipidating process from up to several weeks to two days or less. In addition, due to the non-deformation characteristics of the delipidating and decolorizing composition for tissue clearing of the present invention, it can also be applied to clearing of tissue sections on glass slides, so as to be applied to super-resolution imaging with high signal-to-noise ratio and high-volume rapid clearing imaging.

The delipidating and decolorizing composition for tissue clearing of the present invention or the method for tissue clearing using the same can be applied to ex vivo tissue, in vivo organ, thick section, thin section, whole organ, but is not limited thereto. In particular, it has great potential for application in large animals such as non-human primates due to its advantage of perfusion delipidating.

### BRIEF DESCRIPTION OF DRAWINGS

The drawings described in the present invention are only for illustrating selected embodiments of the present invention, not all possible embodiments, and are not intended to limit the scope of the present invention.

FIG. 1 shows a schematic diagram of the chemical structures of several different types of delipidating molecules, in which type 1 is the urea type, such as urea; type 2 is fatty acid chain anionic surfactants, such as dodecyl sulfate ions; type 3 is nonionic surfactants, such as Triton X-100; type 4 is cholic acid chain zwitterionic surfactants, such as 3-[3-(cholamidopropyl)dimethylamino]propanesulfonic acid internal salt (CHAPS); type 5 is cholic acid anionic surfactants, such as deoxycholate ions; and type 6 is fatty acid chain zwitterionic surfactants (betaine-based surfactants), such as lauramidopropyl hydroxysulfobetaine (LHSB).

FIG. 2 shows the effects of several different types of delipidating molecules on a size of a tissue, in which types 1 to 6 are shown in FIG. 1 respectively. It can be seen that the cholic acid anionic surfactants of type 5, including N,N-diisopropylethanolamine-bile acid salt (DIDC), do not cause the deformation of the tissue; the betaine-based surfactants of type 6 do not cause the deformation of the tissue, either, while other types cause different degrees of tissue expansion.

FIG. 3 shows the results of the determination of the delipidating ability of several different types of delipidating molecules, in which types 1 to 6 are shown in FIG. 1, respectively.

FIG. 4 is a diagram showing the result of a delipidating effect of tissue clearing by using the delipidating and decolorizing composition according to an embodiment of the present invention as compared with the clearing method of the prior art.

FIG. 5 is a diagram showing the result of the deformation of the tissue, delipidating efficiency, and fluorescence signal retention of tissue clearing by using the delipidating and decolorizing composition according to an embodiment of the present invention as compared with the clearing method of the prior art.

FIG. 6 shows photographs of the result of whole organ clearing of mouse by using the delipidating and decolorizing composition according to an embodiment of the present invention. From left to right, the top photographs show the photographs of a brain of the mouse before delipidating and decolorizing, after delipidating and decolorizing, and after refractive index matching. The bottom photograph shows photographs of the morphology of the heart, liver, spleen, lung, kidney, and brain of the mouse after clearing.

FIG. 7 shows photographs of the results of imaging 200 micron thick brain sections of the Thyl-YFP mouse subjected to clearing treatment. In FIG. 7, a) only refractive index matching is carried out without delipidating and decolorizing reagent treatment; b) a rapid pre-delipidating and decolorizing reagent is used for treatment and a refractive index matching is carried out; c) a rapid pre-delipidating and decolorizing reagent and a final delipidating and decolorizing reagent are used for treatment and a refractive index matching is carried out; d) maximum brightness projection images of three-dimensional imaging from two viewpoints, the left side is after clearing treatment and the right side is before clearing treatment; e) a bright field image after clearing treatment is completed; f) a bright field image with refractive index matching only; and g) a bright field image of 100 micron brain sections of the mouse without any clearing treatment.

### DETAILED DESCRIPTION

Hereinafter, embodiments of the present invention will be described in more detail to aid in understanding the present invention. It is to be understood that the description of these embodiments is for illustrative purposes only and is not intended to limit the scope of protection claimed in the invention in any way.

Because the clearing requires relative large changes in the properties of various components of the tissue, almost all clearing methods of the prior art cannot achieve the maintenance of the size of the tissue and the guarantee of tissue morphology, that is, the influence of clearing method itself on organ tissue structure cannot be ruled out. In addition, various clearing methods of the prior art are insufficient to maintain endogenous fluorescence, so that weak signals cannot be detected more effectively. The maintenance of macroscopic morphology and the maintenance of endogenous fluorescence are both essentially the protection of protein structure. A high concentration of urea commonly used in the existing aqueous clearing method, an organic solvent in the organic solvent clearing method, and a high-concentration strong anionic detergent in the gel clearing method are all factors leading to protein denaturation.

After thoroughly studying various surfactants in delipidating ability, influence on tissue morphology, and influence on endogenous fluorescent proteins, the inventor(s) has found that a betaine-based surfactant and a cholic acid-based surfactant are compounded, which not only can achieve delipidating and decolorizing significantly superior to the methods of the prior art, but also cannot cause the deformation of the tissue especially in the case that urea and urea analogs or amide bond-containing agents having hyperhydration and strong ionic surfactants such as sodium dodecyl sulfate (SDS) are excluded.

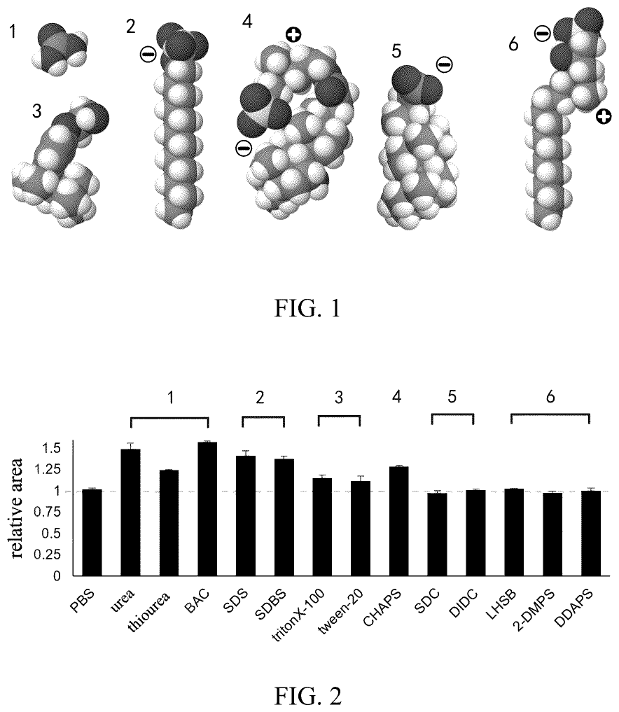

FIG. 1 shows a schematic diagram of the chemical structures of several different types of delipidating molecules, in which type 1 is the urea type, such as urea; type 2 is fatty acid chain anionic surfactants, such as dodecyl sulfate ions; type 3 is nonionic surfactants, such as Triton X-100; type 4 is cholic acid chain zwitterionic surfactants, such as 3-[3-(cholamidopropyl)dimethylamino]propanesulfonic acid internal salt (CHAPS); type 5 is cholic acid anionic surfactants, such as deoxycholate ions; and type 6 is fatty acid chain zwitterionic surfactants (betaine-based surfactants), such as lauramidopropyl hydroxysulfobetaine (LHSB). FIG. 2 shows the effects of several different types of delipidating molecules on a size of a tissue, in which 1 to 6 refer to types 1 to 6 as shown in FIG. 1 respectively. It can be seen that the cholic acid anionic surfactants of type 5, including N,N-diisopropylethanolamine-bile acid salt (DIDC), do not cause the deformation of the tissue; the betaine-based surfactants of type 6 do not cause the deformation of the tissue, either, while other types cause different degrees of tissue expansion.

Thus, in one aspect, the present invention provides a delipidating and decolorizing composition for tissue clearing, and the composition comprises: a betaine-based surfactant containing a fatty acid side chain; and an anionic surfactant containing a cholic acid side chain.

The betaine-based surfactant containing a fatty acid side chain has a rapid tissue delipidating effect, the property of no tissue deformation, good endogenous fluorescence maintenance ability, high chemical stability and extremely high solubility, and solubility enhancement for other functional decoloring agents. In some embodiments, the betaine-based surfactant containing a fatty acid side chain may be selected from one or more of lauramidopropyl hydroxysulfobetaine LHSB, dodecyldimethylhydroxypropyl sulfobetaine, and tetradecyldimethylhydroxypropyl sulfobetaine, but is not limited thereto.

In some embodiments, the composition may comprise about 0% w/v to about 50% w/v of a betaine-based surfactant containing a fatty acid side chain. In some embodiments, the composition may comprise about 1% w/v to about 50% w/v of a betaine-based surfactant containing a fatty acid side chain. Preferably, the content of the betaine-based surfactant containing a fatty acid side chain ranges from about 1% w/v to about 50% w/v, more preferably from about 3% w/v to about 30% w/v, and most preferably from about 3% w/v to about 25% w/v.

In some embodiments, an anionic surfactant containing a cholic acid side chain may comprise a side chain derived from a cholic acid-based compound. Preferably, the cholic acid-based compound may include one or more of cholic acid, lithocholic acid, deoxycholic acid, or chenodeoxycholic acid, but is not limited thereto. In some specific embodiments, the anionic surfactant containing a cholic acid side chain may further form an ammonium salt complex with an amine compound. In particular, an alkaline amine-based decolorizing reagent (e.g., N,N-diisopropylethanolamine) is mixed with a cholic acid-based compound, to obtain an alkaline amine-bile acid salt complex which has the ability of rapid delipidating and rapid decolorizing without introducing other ineffective ions, such as sodium ions in sodium deoxycholate. Preferably, the amine compound is selected from one or more of N,N-diisopropylethanolamine, N-butyldiethanolamine, N,N′,N,N′-tetra-hydroxypropylethylamine tetraacetic acid (Quadrol), 1-(3-aminopropyl)imidazole, triethanolamine, and N-methyldiethanolamine, but is not limited thereto.

In some embodiments, the composition may comprise about 1% w/v to 30% w/v of an anionic surfactant containing a cholic acid side chain. Preferably, the content of the anionic surfactant containing a cholic acid side chain ranges from about 1% w/v to about 30% w/v, more preferably from about 5% w/v to about 25% w/v, and most preferably from about 15% w/v to about 25% w/v.

In some embodiments, an anionic surfactant containing a cholic acid side chain may further form an ammonium salt complex with an amine compound. Preferably, the amine compound is selected from one or more of N,N-diisopropylethanolamine, N-butyldiethanolamine, Quadrol, 1-(3-aminopropyl)imidazole, triethanolamine, and N-methyldiethanolamine, but is not limited thereto. In some specific embodiments, the concentration of the anionic surfactant containing a cholic acid side chain ranges from 1% w/v to 15% w/v, preferably from 3% w/v to 15% w/v, based on the delipidating and decolorizing composition for tissue clearing. In some specific embodiments, the concentration of the amine compound ranges from 1% w/v to 20% w/v, and preferably from 3% w/v to 12% w/v, based on the delipidating and decolorizing composition for tissue clearing.

In some embodiments, the delipidating and decolorizing composition for tissue clearing according to the present invention may further comprise a fluidity enhancer. In some embodiments, the fluidity enhancer may be selected from the group consisting of thiourea compounds and urea, preferably the thiourea compounds comprise thiourea. By further adding a fluidity enhancer to the delipidating and decolorizing composition, fluidity of a cell membrane can be increased, solubility of a lipid can be increased, and tissue morphology can be maintained during the initial stage of delipidating. In preferred embodiments, the delipidating and decolorizing composition comprises 5% w/v to 25% w/v of a fluidity enhancer.

In some embodiments, the delipidating and decolorizing composition according to the present invention is free of urea or urea analogs. In some embodiments, the delipidating and decolorizing composition according to the present invention is free of strong ionic surfactants such as sodium dodecyl sulfate (SDS).

In another aspect, the present invention provides a method for tissue clearing, and the method comprises treating a tissue sample with the delipidating and decolorizing composition for tissue clearing according to the present invention.

In some embodiments, the method for tissue clearing according to the present invention comprises: treating a tissue sample with a first delipidating and decolorizing composition; and
transferring the tissue sample treated with the first delipidating and decolorizing composition into a second delipidating and decolorizing composition,
wherein the first delipidating and decolorizing composition and the second delipidating and decolorizing composition may be the same or different.

In some specific embodiments, the first delipidating and decolorizing composition is different from the second delipidating and decolorizing composition. In some preferred embodiments, the first delipidating and decolorizing composition is free of a fluidity enhancer. In some preferred embodiments, the second delipidating and decolorizing composition comprises a higher content of a betaine-based surfactant containing a fatty acid side chain than the first delipidating and decolorizing composition.

In a particularly preferred embodiment, the first delipidating and decolorizing composition is a composition for rapid pre-delipidating and decolorizing which comprises about 12% w/v sodium deoxycholate, about 10% w/v N,N-diisopropylethanolamine, and about 3% w/v lauramidopropyl hydroxysulfobetaine. In a particularly preferred embodiment, the second delipidating and decolorizing composition is a composition for final delipidating and decolorizing which comprises about 12% w/v sodium deoxycholate, about 10% w/v N,N-diisopropylethanolamine, about 25% w/v lauramidopropyl hydroxysulfobetaine, and about 16% w/v thiourea. In certain preferred embodiments, a first delipidating and decolorizing composition comprising about 12% w/v sodium deoxycholate, about 10% w/v N,N-diisopropylethanolamine, and about 3% w/v lauramidopropyl hydroxysulfobetaine can be used for rapid pre-delipidating and decolorizing, which is capable of rapidly delipidating a tissue at an initial stage and the tissue reaches saturation relatively quickly. And after rapid pre-delipidating and decolorizing by the first delipidating and decolorizing composition, a second delipidating and decolorizing composition comprising about 12% w/v sodium deoxycholate, about 10% w/v N,N-diisopropylethanolamine, about 25% w/v lauramidopropyl hydroxysulfobetaine, and about 16% w/v thiourea can be used for a final delipidating and decolorizing, thereby maximizing the removal of remaining lipids and pigments.

In some embodiments, the method for tissue clearing according to the present invention further comprises holding the tissue sample treated with the delipidating and decolorizing composition in an aqueous refractive index matching liquid.

In some specific embodiments, the method for tissue clearing may comprise the following steps:
1) obtaining a tissue sample to be cleared;
2) subjecting the obtained tissue sample to at least one first delipidating and decolorizing by using a first delipidating and decolorizing composition; preferably, the first delipidating and decolorizing being carried out at about 34 °C to 45 °C for about 8 to 24 hours;
3) subjecting the first delipidated and decolorized tissue sample to a second delipidating and decolorizing by using a second delipidating and decolorizing composition; preferably, said second delipidating and decolorizing being carried out at 34 °C to 45 °C for about 8 to 24 hours; and
4) washing the second delipidated and decolorized tissue sample, and transferring it to an aqueous refractive index matching liquid for holding.

In some specific embodiments, the first delipidating and decolorizing may be carried out for at least one time, for example, one, two, or three or more times.

In some specific embodiments, the tissue sample includes, ex vivo tissue, in vivo organ, thick section, thin section, whole organ, but is not limited thereto. In some specific embodiments, the tissue sample is obtained from a mammal, such as a cow, a horse, a pig, a dog, a sheep, a rat, a mouse, a non-human primate, but is not limited thereto.

Hereinafter, the present invention will be described in more detail by way of Examples. However, the following examples are provided for illustrative purposes only and are not intended to limit the scope of protection of the present invention. Various modifications and variations can be made by those skilled in the art without departing from the scope and spirit of the present invention, and such modifications and variations are also within the scope of the present invention.

### EXAMPLE

### Materials and Methods

Experimental Animals: Adult male or female C57BL/6N mice aged 8-16 weeks were used in the experiments. Mice were anesthetized with excess sodium pentobarbital (>100 mg/kg) prior to perfusion.

### Reagents, Materials, Instruments

1) Determination of the concentration of phospholipid: Phospholipid Assay Kit (MAK122, Sigma-Aldrich); Nanodrop3000 Microvolumn Spectrophotometer (ThermoFisher); En Vision Multimode Microplate Reader (Perkin).
2) Bright field imaging and fluorescence imaging of a size of a tissue, etc.: Fully Automatic Digital Slide Scanning System AxioZ1 (Zeiss); Spinning Disk Confocal Microscope Dragonfly (Andor).
3) Main reagents: deoxycholic acid (D2510, Sigma-Aldrich), sodium deoxycholate (264103, Sigma-Aldrich), N,N-diisopropylethanolamine (D838068, Macklin), N-butyldiethanolamine (N802391, Macklin), 1-(3-aminopropyl)imidazole (272264, Sigma-Aldrich), lauramidopropyl hydroxysulfobetaine (LHSB, Greensense), 3-[3-(cholamidopropyl)dimethylamino]propanesulfonic acid internal salt (CHAPS-RO, Sigma-Aldrich), sodium dodecyl sulfate (V900859, Sigma-Aldrich), sodium dodecylbenzenesulfonate (PHR1305, Sigma-Aldrich), TritonX-100 (T8787, Sigma-Aldrich), urea (U5128, Sigma-Aldrich), and thiourea (T7875, Sigma-Aldrich).

### Example 1. Preparation of a Delipidating and Decolorizing Composition

FIG. 1 shows a schematic diagram of the chemical structures of several different types of delipidating molecules, in which type 1 is the urea type, such as urea; type 2 is fatty acid chain anionic surfactants, such as dodecyl sulfate ions; type 3 is nonionic surfactants, such as Triton X-100; type 4 is cholic acid chain zwitterionic surfactants, such as 3-[3-(cholamidopropyl)dimethylamino]propanesulfonic acid internal salt (CHAPS); type 5 is cholic acid anionic surfactants, such as deoxycholate ions; and type 6 is fatty acid chain zwitterionic surfactants (betaine-based surfactants), such as lauramidopropyl hydroxysulfobetaine (LHSB). The inventor(s) tested the delipidating ability of these types of delipidating molecules and their effect on a size of a tissue.

After the brain of the mouse was post-fixed for 4 hours, the brain of the mouse was cut into 100 micron brain sections by using a vibration microtome, and temporary mounts were prepared by using PBS and photographed with a bright field camera to extract the area of the brain sections. The brain sections were immersed in the corresponding reagents at 37 °C for 24 hours, and the temporary mounts were prepared by using the corresponding reagents and photographed using a bright field camera, to extract the area of the brain sections, so as to obtain the relative area. Referring to FIG. 2, there was shown the effects of on a size of a tissue after the delipidating and decolorizing was carried out by using the several different types of delipidating molecules described above, in which 1 to 6 were the types 1 to 6 as shown in FIG. 1, respectively. It can be seen that the cholic acid anionic surfactants of type 5, including ethanolamine-cholic acid salts (DIDC), did not cause the deformation of the tissue; and the betaine-based surfactants of type 6 did not cause the deformation of the tissue, either, while other types caused different degrees of tissue expansion.

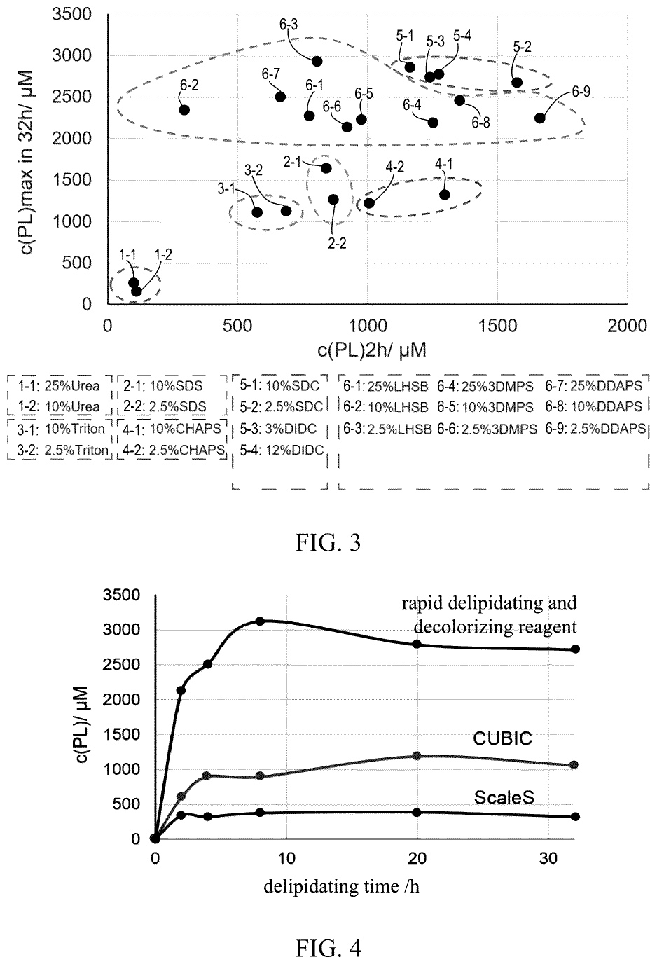

Further, the delipidating ability of different delipidating agents was assessed by determining the highest phospholipid concentration (c(PL)) of brain tissue sections immersed in different delipidating agents for 2 hours and 32 hours. Referring to FIG. 3, it can be seen that the cholic acid anionic surfactants or ethanolamine-bile acid salts of type 5 and the betaine-based surfactants of type 6 had the highest delipidating ability and delipidating rate. Therefore, in order to achieve the best delipidating effect, the inventor(s) compounded these two types of delipidating agents.

Sodium deoxycholate, N,N-diisopropylethanolamine and lauramidopropyl hydroxysulfobetaine and optional thiourea were mixed in solution to prepare a delipidating and decolorizing composition of the present invention. Specifically, a delipidating and decolorizing composition comprising 12% w/v sodium deoxycholate, 10% w/v N,N-diisopropylethanolamine, and 3% w/v lauramidopropyl hydroxysulfobetaine was prepared as a rapid pre-delipidating and decolorizing reagent, which has the ability to rapidly delipidate a tissue at an initial stage and the tissue reaches saturation relatively quickly. In addition, a delipidating and decolorizing composition comprising 12% w/v sodium deoxycholate, 10% w/v N,N-diisopropylethanolamine, 25% w/v lauramidopropyl hydroxysulfobetaine, and 16% w/v thiourea was prepared as a final delipidating and decolorizing reagent, which can maximize the removal of remaining lipids and pigments.

### Example 2. Passive Delipidating, Decolorizing, and Clearing of Thick Sections

Thick tissue sections were passively delipidated, decolorized and cleared by using the rapid pre-delipidating and decolorizing reagent and the final delipidating and decolorizing reagent prepared in Example 1, and the specific steps were as follows:
1—Brain sections of the mouse with a thickness of 300 microns were obtained by a vibration microtome or cryosectioning, and the fixed tissue sections were placed in a rapid pre-delipidating and decolorizing reagent and treated at 37 °C for 12 h.
2—The tissue sections were placed in a new rapid pre-delipidating and decolorizing reagent and the treatment was continued at 37 °C for 12 h.
3—The tissue sections were transferred to the final delipidating and decolorizing reagent and treated at 37 °C for 12 h.
4—The tissue sections were placed in a new final delipidating and decolorizing reagent and the treatment was continued at 37 °C for 12 h.
5—The tissue sections were rinsed with PBS at room temperature for three times, for 10 minutes each time.
6—The tissue sections were transferred to an aqueous refractive index matching liquid, and the aqueous refractive index matching liquid was used to perform sealing sections.

### Example 3. Delipidating, Decolorizing and Clearing of the Sections on Glass Slides

Tissue sections attached to a glass slide were delipidated, decolorized and cleared by using the rapid pre-delipidating and decolorizing reagent and the final delipidating and decolorizing reagent prepared in Example 1, and the specific steps were as follows:
1—Brain sections of the mouse with a thickness of 50 microns were obtained by a vibration microtome or cryosectioning, the tissue sections were attached to glass slides and the glass slides were placed in PBS to thoroughly wash out the embedding agent 2-3 times.
2—The glass slides were placed in a staining tank, to which a rapid pre-delipidating and decolorizing reagent was added, and the tissue sections were incubated at 37 °C for 1 h.
3—The reagent in the staining tank was replaced with the final delipidating and decolorizing reagent and the tissue sections were incubated at 37 °C for 1 h.
4—The glass slides were placed in PBS to thoroughly wash off the delipidating and decolorizing reagent for 2-3 times.
5—Excess PBS was removed and an aqueous refractive index matching liquid was used to perform sealing sections.

### Example 4: Clearing of In Vivo Transcardiac Perfused Whole Organ

Clearing of transcardiac perfused whole organ was carried out on mice by using the rapid pre-delipidating and decolorizing reagent and the final delipidating and decolorizing reagent prepared in Example 1, and the specific steps were as follows:
1—The transcardiac perfusion was carried out on the mice by using pre-cooled heparin-saline solution, until the blood was sufficiently drained.
2—The transcardiac perfusion was carried out on the mice by using 4% paraformaldehyde (containing 0.01 M phosphate buffer) for 15 min.
3—The transcardiac perfusion was carried out on the mice by using 15 ml of a rapid pre-delipidating and decolorizing reagent, and a cycle was established to recover the liquid to continue the perfusion for 8 hours.
4—15 ml of a new rapid pre-delipidating and decolorizing reagent was displaced, and the perfusion was carried out for 8 h cyclically.
5—15 ml of a final delipidating and decolorizing reagent was displaced, and the perfusion was carried out for 8 h cyclically.
6—15 ml of a new final delipidating and decolorizing reagent was displaced, and the perfusion was carried out for 8 h cyclically.
7—The organ was taken out and rinsed with PBS to remove the delipidating and decolorizing reagent.
8—The organ was immersed in an aqueous refractive index matching liquid.

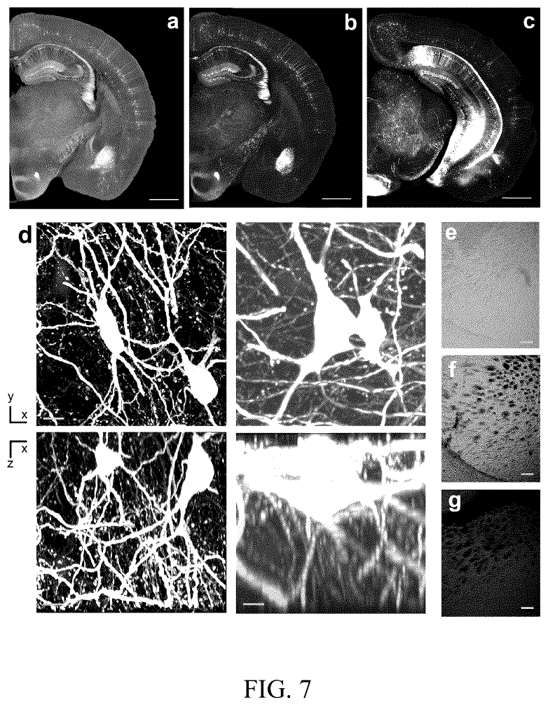

FIG. 6 shows photographs of the result of whole organ clearing of mouse by using the delipidating and decolorizing composition according to an embodiment of the present invention. From left to right, the top photographs show the photographs of a brain of the mouse before delipidating and decolorizing, after delipidating and decolorizing, and after refractive index matching. The bottom photograph shows photographs of the morphology of the heart, liver, spleen, lung, kidney, and brain of the mouse after clearing. Herein, after the delipidating and decolorizing was carried out by a method of perfusion, the refractive index matching agent was used to carry out a refractive index matching, and the clearing of the whole organ was realized.

### Example 5: Delipidating Effect of Rapid Delipidating and Decolorizing Compositions

We further compared a rapid delipidating and decolorizing reagent of the present invention with delipidating and decolorizing reagents and methods commonly used in the prior art in terms of the delipidating rate, the deformation of the tissue, and the protection of fluorescent signals etc.

A brain tissue of the mouse post-fixed for 1 day and dehydrated with 30% sucrose for 2 days was cut into sections with 300 micron by using a cryoslicer and immediately weighed. The rapid pre-delipidating and decolorizing reagent (comprising 12% w/v sodium deoxycholate, 10% w/v N,N-diisopropylethanolamine, and 3% w/v lauramidopropyl hydroxysulfobetaine) prepared in Example 1 equivalent to 20 times the mass of a brain section of the mouse was added for clearing treatment of the tissue. In addition, CUBIC-X delipidater (25% w/v urea, 5% w/v Quadrol (N,N′,N,N′-tetra-hydroxypropylethylamine tetraacetic acid), 15% w/v TritonX-100) or ScaleS clearing reagent (24% w/v urea, 10% w/v glycerol, 40% w/v sorbitol, 0.2% w/v TritonX-100, 15% w/v DMSO) were used for the same brain sections of the mouse respectively, for clearing treatment of the tissue. Brain sections of the mouse treated respectively with the rapid delipidating and decolorizing reagent of the present invention, CUBIC-X delipidating agent or ScaleS clearing reagent were sampled at different points of time, and changes of the relative area, phospholipid content of supernatant and changes of relative fluorescence of the three groups of brain sections were determined respectively. For fluorescence assays, thyl-YFP mouse was used, and the green fluorescence intensity of cells labeled with fluorescence was determined.

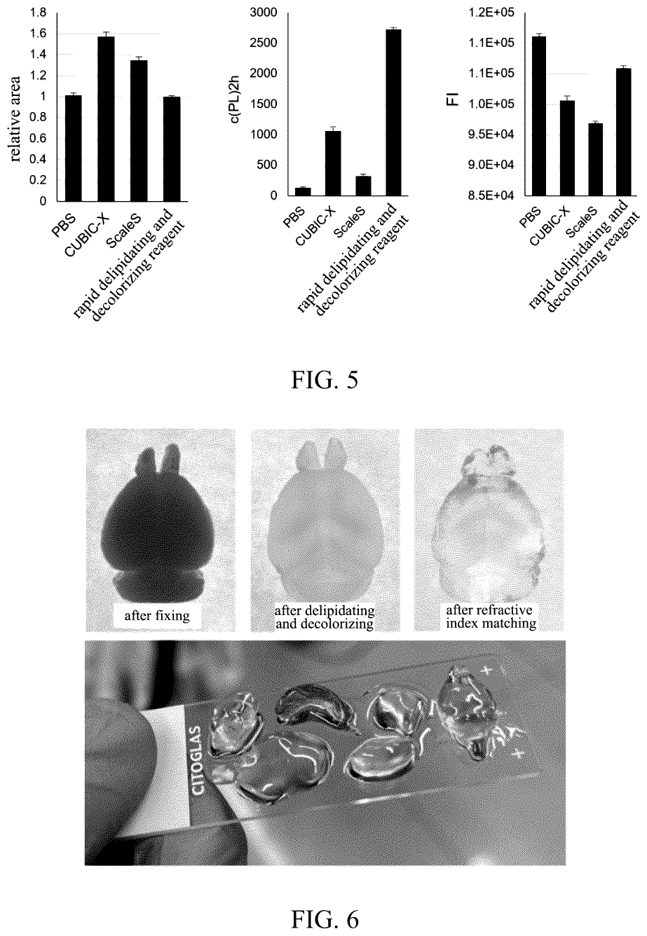

FIG. 4 is a diagram showing the result of a delipidating effect of tissue clearing by using the delipidating and decolorizing composition according to an embodiment of the present invention as compared with the clearing method of the prior art. It can be seen that the delipidating rate of using the rapid pre-delipidating and decolorizing reagent of Example 1 was significantly faster as compared with that of using the delipidating and decolorizing reagents in the classical aqueous clearing methods CUBIC and ScaleS. FIG. 5 is a diagram showing the result of the deformation of the tissue, delipidating efficiency, and fluorescence signal retention of tissue clearing by using the delipidating and decolorizing composition according to an embodiment of the present invention as compared with the clearing method of the prior art. It can be seen that using the rapid pre-delipidating and decolorizing reagent of Example 1 did not cause the deformation of the tissue of brain sections during delipidating and decolorizing (left), the delipidating efficiency was higher (middle), and the GFP fluorescence signal was better protected (right), as compared with using the delipidating and decolorizing reagents in the classical aqueous clearing methods CUBIC and ScaleS.

### Example 6: Effect of the Delipidating and Decolorizing Composition on Imaging Effects

The improvement of tissue clearing by using a delipidating and decolorizing reagent of the present invention on imaging effects was further tested. Tissue clearing was carried out by using the rapid pre-delipidating and decolorizing reagent and the final delipidating and decolorizing reagent prepared in Example 1. FIG. 7 shows photographs of the results of imaging 200 micron thick brain sections of the Thyl-YFP mouse subjected to clearing treatment. In FIG. 7, the a, b, c, and d were taken by using a spinning disk confocal microscope, in which the a, b, and c were taken by using a 10× airlens, and the d was taken by using a 20× airlens, all of which took 488/520 green fluorescence channels. The e, f, and g in FIG. 7 were taken by using a bright-field light source of a wide-field microscope and a camera.

In FIG. 7, a) only refractive index matching is carried out without delipidating and decolorizing reagent treatment; b) a rapid pre-delipidating and decolorizing reagent is used for treatment and a refractive index matching is carried out; c) a rapid pre-delipidating and decolorizing reagent and a final delipidating and decolorizing reagent are used for treatment and a refractive index matching is carried out (complete clearing treatment); d) maximum brightness projection images of three-dimensional imaging from two viewpoints, the left side is after clearing treatment and the right side is before clearing treatment; e) a bright field image after complete clearing treatment; f) a bright field image with refractive index matching only; g) a bright field image of 100 micron brain sections of the mouse without any clearing treatment. It can be seen from FIG. 7 that the imaging effect after the treatment with the delipidating and decolorizing reagent of the present invention is significantly improved as compared with the tissue section which is not subjected to the clearing treatment at all or to only the refractive index matching treatment. Furthermore, further treatment with a final delipidating and decolorizing reagent after the treatment with a rapid pre-delipidating and decolorizing reagent achieves better imaging effects, as compared with the treatment with a rapid pre-delipidating and decolorizing reagent alone.

1. A delipidating and decolorizing composition for tissue clearing, comprising:
a betaine-based surfactant containing a fatty acid side chain; and
an anionic surfactant containing a cholic acid side chain.

2. The delipidating and decolorizing composition for tissue clearing according to claim 1, wherein the betaine-based surfactant containing the fatty acid side chain is selected from one or more of lauramidopropyl hydroxysulfobetaine, dodecyldimethylhydroxypropyl sulfobetaine, tetradecyldimethylhydroxypropyl sulfobetaine, N,N-dimethyl-N-dodecylglycine betaine, tetradecylsulfobetaine, and lauryldimethylsulfobetaine.

3. The delipidating and decolorizing composition for tissue clearing according to claim 1, wherein the composition comprises 0% w/v to 50% w/v of the betaine-based surfactant containing the fatty acid side chain.

4. The delipidating and decolorizing composition for tissue clearing according to claim 1, wherein the composition comprises 1% w/v to 50% w/v of the betaine-based surfactant containing the fatty acid side chain.

5. The delipidating and decolorizing composition for tissue clearing according to claim 1, wherein the anionic surfactant containing the cholic acid side chain comprises a side chain derived from a cholic acid-based compound.

6. The delipidating and decolorizing composition for tissue clearing according to any one of claim 1, wherein the composition comprises 0.5% w/v to 35% w/v of the anionic surfactant containing the cholic acid side chain.

7. The delipidating and decolorizing composition for tissue clearing according to claim 1, wherein the anionic surfactant containing the cholic acid side chain further forms an ammonium salt complex with an amine compound.

8. The delipidating and decolorizing composition for tissue clearing according to claim 1, wherein the composition further comprises a fluidity enhancer.

9. A method for tissue clearing, comprising treating a tissue sample with the delipidating and decolorizing composition for tissue clearing according to claim 1.

10. The method for tissue clearing according to claim 9, wherein the method comprises:
treating the tissue sample with a first delipidating and decolorizing composition; and optionally
transferring the tissue sample treated with the first delipidating and decolorizing composition into a second delipidating and decolorizing composition,
wherein the first delipidating and decolorizing composition and the second delipidating and decolorizing composition are the same or different, and are the delipidating and decolorizing composition for tissue clearing according to claim 1.

11. The method for tissue clearing according to claim 10, wherein the method further comprises holding the tissue sample treated with the delipidating and decolorizing composition in an aqueous refractive index matching liquid.

12. The delipidating and decolorizing composition for tissue clearing according to claim 5, wherein the cholic acid-based compound is selected from one or more of cholic acid, lithocholic acid, deoxycholic acid, and chenodeoxycholic acid.

13. The delipidating and decolorizing composition for tissue clearing according to claim 1, wherein the anionic surfactant containing the cholic acid side chain further forms an ammonium salt complex with an amine compound, and the amine compound is selected from one or more of N,N-diisopropylethanolamine, N-butyldiethanolamine, N,N′,N,N′-tetra-hydroxypropylethylamine tetraacetic acid, 1-(3-aminopropyl) imidazole, triethanolamine, and N-methyldiethanolamine.

14. The delipidating and decolorizing composition for tissue clearing according to claim 7, wherein a concentration of the anionic surfactant containing the cholic acid side chain is from 1% w/v to 15% w/v, and a concentration of the amine compound is from 1% w/v to 20% w/v, based on the delipidating and decolorizing composition for tissue clearing.

15. The delipidating and decolorizing composition for tissue clearing according to claim 8, wherein the fluidity enhancer is selected from thiourea compounds and urea.

16. The delipidating and decolorizing composition for tissue clearing according to claim 15, wherein the thiourea compounds comprise thiourea.

17. The delipidating and decolorizing composition for tissue clearing according to claim 8, wherein the composition comprises 5% w/v to 25% w/v of the fluidity enhancer.

18. The method for tissue clearing according to claim 10, wherein the second delipidating and decolorizing composition is different from the first delipidating and decolorizing composition.

19. The method for tissue clearing according to claim 10, wherein the first delipidating and decolorizing composition is free of a fluidity enhancer.

20. The method for tissue clearing according to claim 10, wherein the second delipidating and decolorizing composition comprises a higher content of a betaine-based surfactant containing a fatty acid side chain than the first delipidating and decolorizing composition.
